(19) United States
(12) Patent Application Publication
(10) Pub. No.: US 2025/0379623 A1
(43) Pub. Date: Dec. 11, 2025

(54) DECOUPLED DOWNLINK AND UPLINK BEAM MANAGEMENT

(71) Applicant: QUALCOMM Incorporated, San Diego, CA (US)

(72) Inventors: Fang YUAN, Beijing (CN); Yan ZHOU, San Diego, CA (US); Ruhua HE, San Diego, CA (US); Jun ZHU, San Diego, CA (US); Mihir Vijay LAGHATE, San Diego, CA (US); Raghu Narayan CHALLA, San Diego, CA (US); Alexei Yurievitch GOROKHOV, San Diego, CA (US); Tao LUO, San Diego, CA (US)

(21) Appl. No.: 18/877,099

(22) PCT Filed: Aug. 23, 2022
(86) PCT No.: PCT/CN2022/114127

§ 371 Date: Dec. 19, 2024

(51) Int. Cl. H04B 7/06; H04B 17/309

(52) U.S. Cl. CPC H04B 7/0626; H04B 7/06958; H04B 17/309

(57) ABSTRACT

Certain aspects of the present disclosure provide techniques for decoupled downlink (DL) and uplink (UL) beam management. In an exemplary method, a user equipment obtains an indication to report beam quality of an uplink (UL) beam and a downlink (DL) beam that are decoupled and reports a beam quality of at least one of the UL beam or the DL beam according to the indication.

### BACKGROUND

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes obtaining an indication to report beam quality of an uplink (UL) beam and a downlink (DL) beam that are decoupled; and reporting a beam quality of at least one of the UL beam or the DL beam according to the indication.

Another aspect provides a method for wireless communications by a network entity. The method includes sending an indication to report beam quality of an UL beam and a DL beam that are decoupled; and receiving a report of a beam quality of at least one of the UL beam or the DL beam according to the indication.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A and 5B depict examples of a user equipment (UE) communicating with a network entity via decoupled uplink (UL) and downlink (DL) beams.

FIG. 6 depicts an example of a UE communicating with a network entity via decoupled UL and DL beams.

FIG. 7 depicts a call flow for communications in a network between a network entity and a UE.

FIG. 8A depicts an example timeline of a synchronization signal block (SSB) based joint network and UE beam sweeping beam management procedure.

FIG. 8B depicts in block form example beam reports that the UE may transmit in the timeline in FIG. 8A.

FIG. 9A depicts an example timeline of an SSB based P1 beam management procedure.

FIG. 9B depicts the UE, a best DL beam for an SSB, and a best UL beam for the SSB of FIG. 9A.

FIG. 9C depicts in block form an example beam report that the UE may transmit in the timeline of FIG. 9A.

FIG. 10 depicts in block form an example beam report that the UE may transmit in the timeline shown in FIG. 9A.

FIG. 11A depicts an example timeline of a P2 beam management procedure.

FIG. 11B depicts the UE from FIG. 11A and the receive beam of the UE associated with an SSB.

FIG. 11C depicts in block form an example DL only beam report that the UE may transmit in the timeline of FIG. 11A.

FIG. 12A depicts an example timeline of a P2 beam management procedure.

FIG. 12B depicts the UE from FIG. 12A and the receive beam of the UE associated with an SSB.

FIG. 12C depicts in block form an example UL only beam report that the UE may transmit in the timeline of FIG. 12A.

FIG. 13A depicts an example timeline of a P2 beam management procedure.

FIG. 13B depicts the UE from FIG. 13A and the best DL beam of the UE associated with an SSB.

FIG. 13C depicts the UE from FIG. 13A and the best UL beam of the UE associated with an SSB.

FIG. 14 depicts in block form an example beam report that the UE may transmit in the timeline of FIG. 13A.

FIG. 15A depicts an example timeline of a P3 beam refinement procedure without report.

FIG. 15B depicts the UE from FIG. 15A and the receive beam of the UE associated with an SSB.

FIG. 16A depicts an example timeline of a P3 beam refinement procedure without report.

FIG. 16B depicts the UE from FIG. 16A and the transmit beam of the UE associated with an SSB.

FIG. 17A depicts an example timeline of a P3 beam refinement procedure.

FIG. 17B depicts the UE from FIG. 17A and the receive beam of the UE associated with an SSB.

FIG. 17C depicts the UE from FIG. 17A and the transmit beam of the UE associated with an SSB.

FIG. 18 depicts a method for wireless communications.

FIG. 19 depicts a method for wireless communications.

FIG. 20 depicts aspects of an example communications device.

FIG. 21 depicts aspects of an example communications device.

### DETAILED DESCRIPTION

Aspects of the present disclosure provide apparatuses, methods, processing systems, and computer-readable mediums for decoupled DL and UL beam management.

In typical wireless communications networks that use beamforming, UEs receive DL signals on DL beams and transmit UL signals on UL beams that are both selected based on layer 1 (L1) metrics of the DL beam. Thus, the UL beams and DL beams are transmitted along the same physical path. In some cases, an UL beam that provides superior UL communications is not the reverse of the DL beam having the best L1 metrics. For example, a DL beam may be a best DL beam to a UE, but the UE is limited in the power level the UE can use to transmit on the corresponding UL beam because of a maximum permissible exposure (MPE) parameter of the UE and the UE could transmit with a higher power level on a different UL beam. In another example, a UE could save power by switching from transmitting via a narrow beam to transmitting via a wide beam, but the network selects to transmit to the UE on the narrow beam to get higher DL throughput or signal quality. If the UE switches to a different beam that does not match the beam selected by the network entity, then the network entity may not receive UL transmissions from the UE.

Aspects of the present disclosure provide techniques for decoupled downlink (DL) and uplink (UL) beam management. In the provided techniques, a UE can inform a network entity that receive and transmit beams used by the UE are different for a given network entity beam, so that the network entity will use the correct beam for receiving from the UE and the UE can transmit and receive on different beams.

By enabling a UE to transmit and receive on different beams, throughput from the UE to the network and reliability of communications may be improved, as in some cases the UE can select beams that improve the throughput from the UE to the network, and in other cases, the UE can select beams for UL transmission that can use higher transmit power than an UL beam matching a DL beam selected by the network entity. In addition, a UE may sometimes conserve power by selecting a different UL beam than an UL beam matching a DL beam selected by the network entity.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

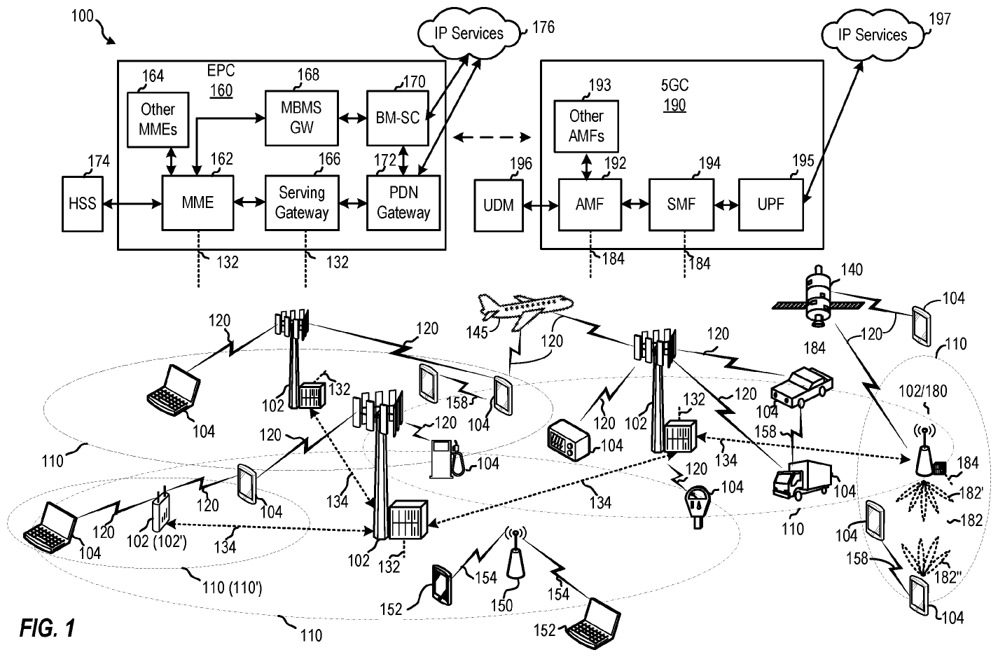

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

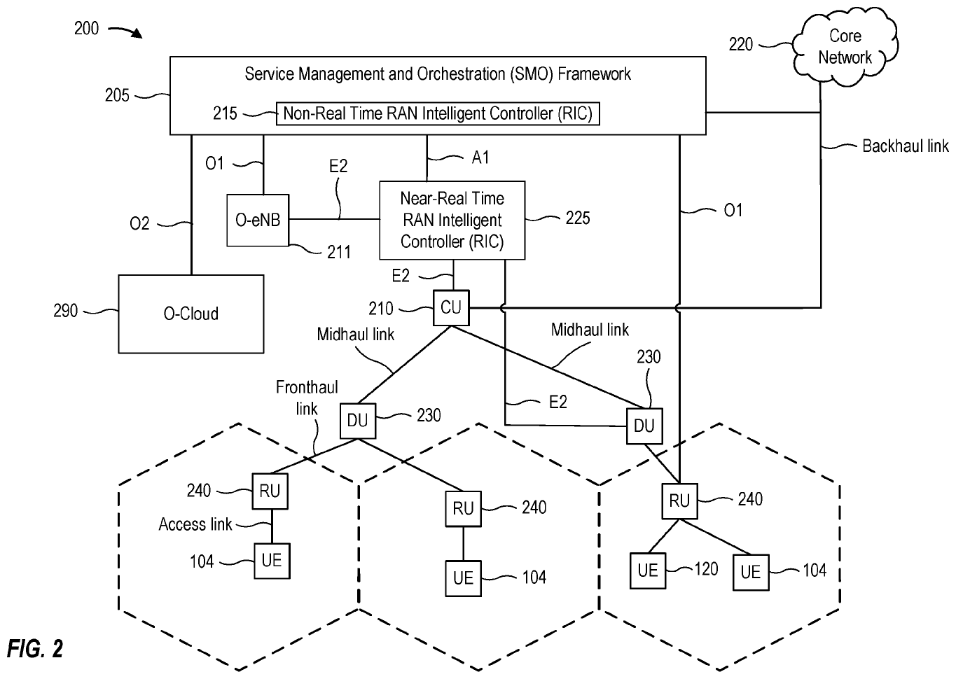

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

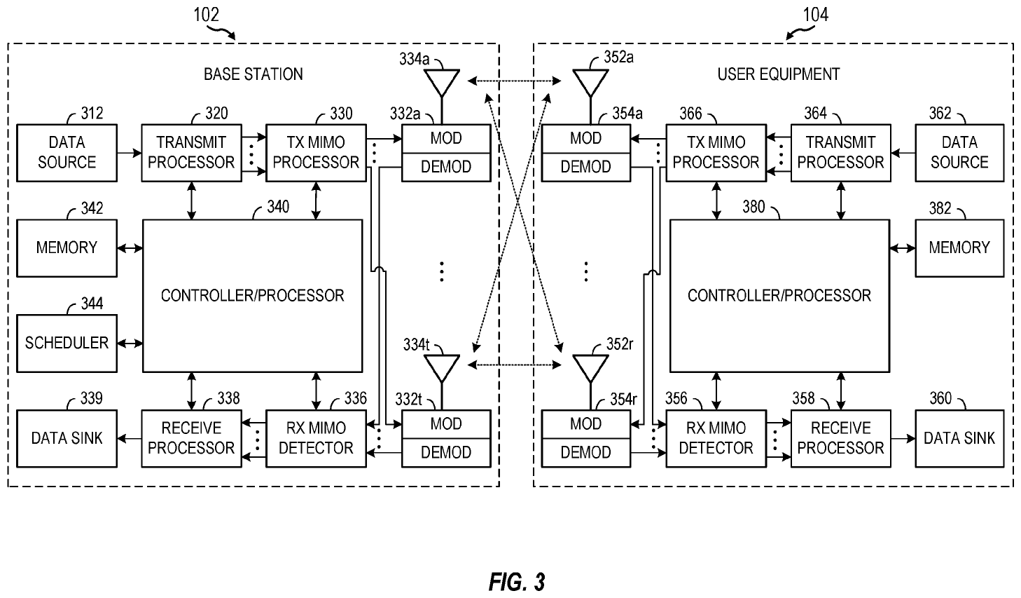

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

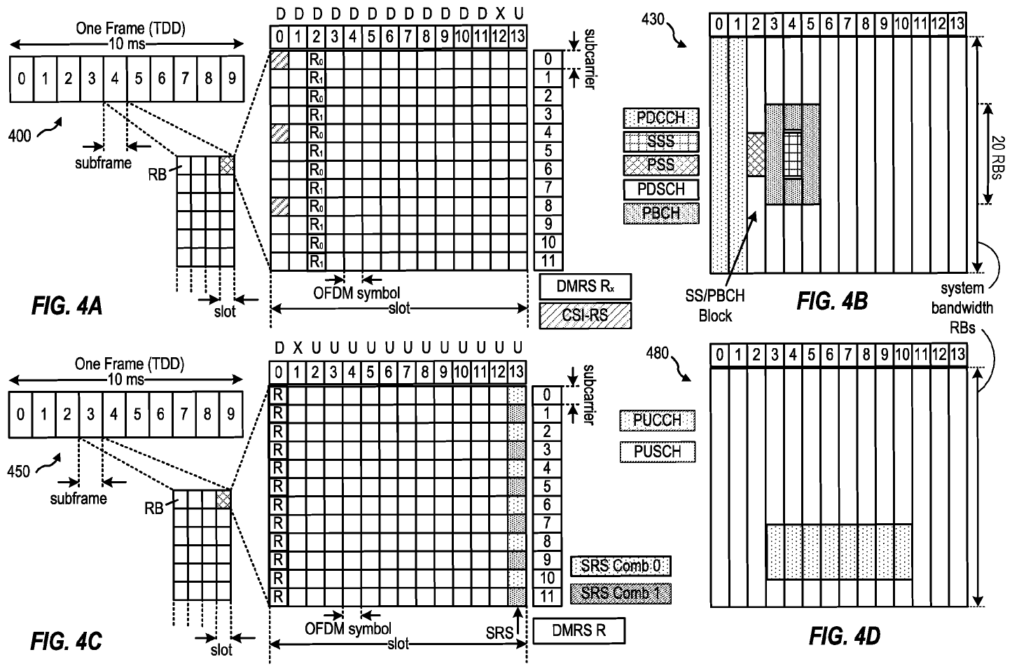

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Forming and Management Procedures

In typical wireless communications systems, various beam forming and management procedures may be used for determining and maintaining beam pair links (BPLs).

An example beam forming and management procedure used in typical wireless communications systems is referred to as a P1 procedure. In a P1 procedure, a network entity (e.g., such as the BS 102 in FIG. 1 and FIG. 3) may send a measurement request to a UE (e.g., such as the UE 104 in FIG. 1 and FIG. 3), and may subsequently transmit one or more signals (sometimes referred to as a “P1-signal”) to the UE for measurement. In the P1 procedure, the network entity transmits a signal with beam forming in a different spatial direction 182′ (corresponding to a transmit (TX) beam) in each symbol, such that several (e.g., most or all) relevant spatial locations of a cell of the network entity are reached. In this manner, the network entity transmits the signal using different transmit beams over time in different directions. In some examples, a synchronization signal block (SSB) is used as the P1-signal. In some examples, channel state information reference signal (CSI-RS), demodulation reference signal (DMRS), or another downlink signal can be used as the P1-signal.

In the P1 procedure, to successfully receive at least a symbol of the P1-signal, the UE finds (e.g., determines/selects) an appropriate receive (RX) beam. Signals (e.g., SSBs) from multiple network entities can be measured simultaneously for a given signal index (e.g., a SSB index) corresponding to a given time period. The UE can apply a different receive beam (corresponding to a different spatial direction 182″) during each occurrence (e.g., each symbol) of the P1-signal. Once the UE succeeds in receiving a symbol of the P1-signal, the UE and the network entity have discovered a BPL (i.e., the UE RX beam used to receive the P1-signal in the symbol and the network entity TX beam used to transmit the P1-signal in the symbol). In some cases, the UE does not search all of its possible UE RX beams until the UE finds a best UE RX beam, since this causes additional delay. Instead, the UE may select a RX beam once the RX beam is “good enough”, for example, having a quality (e.g., a signal to noise ratio (SNR) or a signal to interference and noise ratio (SINR)) that satisfies a threshold (e.g., a predefined threshold). The UE may not know which beam the network entity used to transmit the P1-signal in a symbol; however, the UE 420 may report to the BS 410 the time at which it observed the signal. For example, the UE may report a symbol index in which the P1-signal was successfully received to the network entity. The network entity may receive this report and determine which network entity TX beam the network entity used at the indicated time. In some examples, the UE measures signal quality of the P1-signal, such as a reference signal receive power (RSRP) or another signal quality parameter (e.g., a SNR, a channel flatness, etc.). The UE may report the measured signal quality (e.g., a RSRP) to the network entity together with the symbol index. In some cases, the UE may report multiple symbol indices to the network entity, corresponding to multiple network entity TX beams.

As a part of a beam forming and management procedure, the BPL used between the UE and the BS may be refined/changed. For example, the BPL may be refined periodically to adapt to changing channel conditions, for example, due to movement of the UE or other objects, fading due to Doppler spread, etc. The UE can monitor a quality of the BPL (e.g., a BPL found/selected during the P1 procedure and/or a previously refined BPL) to refine the BPL when the quality drops (e.g., when the BPL quality drops below a threshold or when another BPL has a higher quality). In typical wireless communications systems, the beam forming and management procedures for the beam refinement of the BPLs may be referred to as a P2 procedure and a P3 procedure to refine a network entity beam and a UE beam, respectively, of an individual BPL.

In a typical wireless communications system, for the P2 procedure, the network entity transmits symbols of a signal with different network entity beams that are spatially close to the network entity beam of the current BPL. For example, the network entity transmits the signal in different symbols using neighboring TX beams (e.g., beam sweeps) around the TX beam of the current BPL. The TX beams used by the network entity for the P2 procedure may be different from the TX beams used by the network entity for the P1 procedure. For example, the TX beams used by the network entity for the P2 procedure may be spaced closer together and/or may be more focused (e.g., narrower) than the TX beams used by the network entity for the P1 procedure. During the P2 procedure, the UE keeps its RX beam constant. The UE may measure the signal quality (e.g., a RSRP) of the signal in the different symbols and indicate the symbol in which the highest signal quality was measured. Based on the indication, the network entity can determine the strongest (e.g., best, or associated with the highest signal quality) TX beam (i.e., the TX beam used in the indicated symbol). The BPL can be refined accordingly to use the indicated TX beam.

In a typical wireless communications system, for the P3 procedure, the network entity maintains a constant TX beam (e.g., the TX beam of the current BPL) and transmits symbols of a signal using the constant TX beam. During the P3 procedure, the UE scans the signal using different RX beams in different symbols. For example, the UE may perform a sweep using neighboring RX beams to the RX beam in the current BPL (i.e., the BPL being refined). The UE may measure the signal quality (e.g., a RSRP) of the signal for each RX beam and identify the strongest UE RX beam. The UE may use the identified RX beam for the BPL. The UE may report the signal quality to the network entity.

### Aspects Related to Decoupled Downlink and Uplink Beam Management

In typical wireless communications networks that use beamforming, UEs receive DL signals on DL beams and transmit UL signals on UL beams that are both selected based on layer 1 (L1) metrics of the DL beam. Thus, the UL beams and DL beams are transmitted along the same physical path.

In aspects of the present disclosure, a UE may receive DL signals from a network entity on a DL beam and transmit UL signals to the network entity on an UL beam that is different from the DL beam. The DL beam and UL beam may be associated with a same reference signal in beam reporting. In such cases, the UL beam and the DL beam are referred to as decoupled.

According to aspects of the present disclosure, an UL beam may be selected for UL transmissions by a UE using decoupled UL and DL beams based on UL throughput for the UE. In such cases, a DL beam may be selected for DL transmissions to the UE based on DL throughput to the UE.

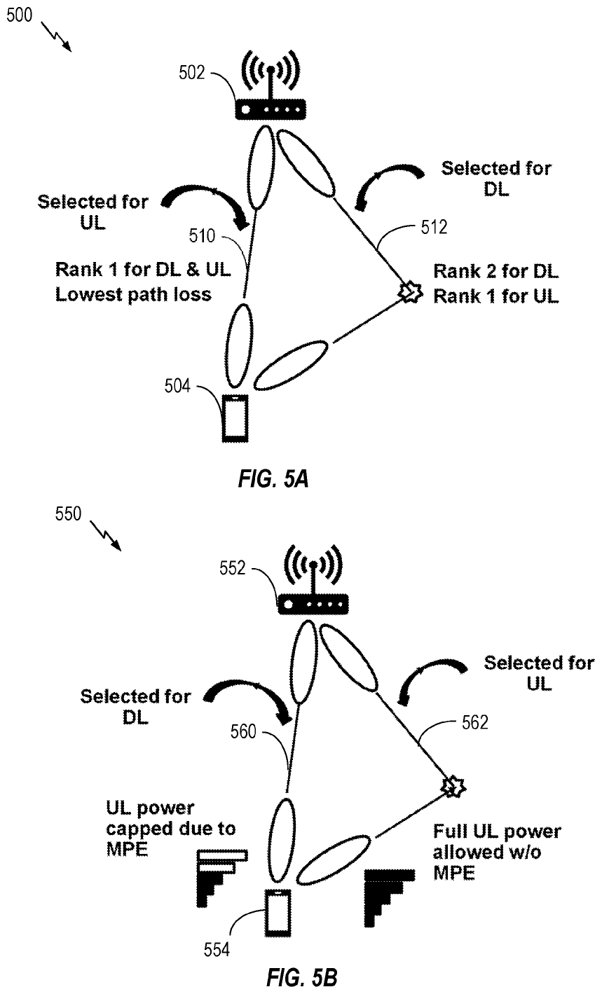

FIG. 5A depicts an example of a UE 504 communicating with a network entity 502 via decoupled UL and DL beams, in accordance with aspects of the present disclosure. The network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. In the example, the beam pair 512 provides rank 2 for DL communications from the network entity to the UE and rank 1 for UL communications from the UE to the network entity, due to limited UL transmit power preventing the use of rank 2 communications on the uplink on beam pair 512. The beam pair 510 provides rank 1 for both DL and UL communications with a higher link quality than the beam pair 512, because the beam pair 510 has lower pathloss than the beam pair 512. In the example, both DL and UL throughput can be optimized if the DL and UL beam selection is decoupled for the communications between the UE and the network entity. For example, DL throughput can be optimized by using beam pair 512 for the DL communications, and UL throughput can be optimized by using beam pair 510 for the UL communications.

In aspects of the present disclosure, an UL beam may be selected for UL transmissions by a UE using decoupled UL and DL beams based on a maximum permissible exposure (MPE) parameter of the UE. In such cases, a DL beam may be selected for DL transmissions to the UE based on DL throughput to the UE or L1 metrics of the DL beam.

FIG. 5B depicts an example 550 of a UE 554 communicating with a network entity 552 via decoupled UL and DL beams, in accordance with aspects of the present disclosure. The network entity 552 may be an example of the BS 102 depicted and described with respect to FIGS. 1 and 3 or a disaggregated base station depicted and described with respect to FIG. 2. Similarly, the UE 554 may be an example of UE 104 depicted and described with respect to FIGS. 1 and 3. In the example, UL transmit power of the UE beam 560 may be capped due to MPE, while the UE beam 562 does not suffer from the MPE limitation. In this case, UL performance can be improved by choosing beam 562 for UL communications, while using the beam 560 for DL communications may improve DL performance, for example, if beam 560 has the best DL reference signal received power (RSRP). Choosing an UL beam based on an MPE parameter of the UE may be beneficial, especially when the MPE issue is not significant enough to trigger an MPE report for UL beam replacement.

According to aspects of the present disclosure, a UE may use decoupled receive and transmit beams for a same transmission configuration indicator (TCI) state. In some cases, a UE can autonomously switch from transmitting via a narrow UL beam (configured by a network entity based on, for example, L1 metrics of a DL beam) to transmitting via a wide beam (e.g., using a single antenna element) in order to save power if lower UL throughput is acceptable for operations of the UE (e.g., the UE is not generating large amounts of UL traffic). It should be noted that using the wide UL beam may not cause any issue if the wide UL beam contains the narrow UL beam, because the network entity will still be able to receive the UL transmissions via the wide UL beam.

In some cases, if transmit power on an UL beam (configured by a network entity) is limited because of MPE, the UE can autonomously choose an UL beam on which the transmit power is not limited by MPE.

In some cases, if an UL beam (configured by a network entity) has lower UL throughput than another UL beam, a UE can autonomously choose the UL beam with the better UL throughput.

In each of these cases, the UL beam that is decoupled from the DL beam for the same TCI state may not be received by a network entity, if the network entity uses a beam selected in a P2 beam sweeping procedure.

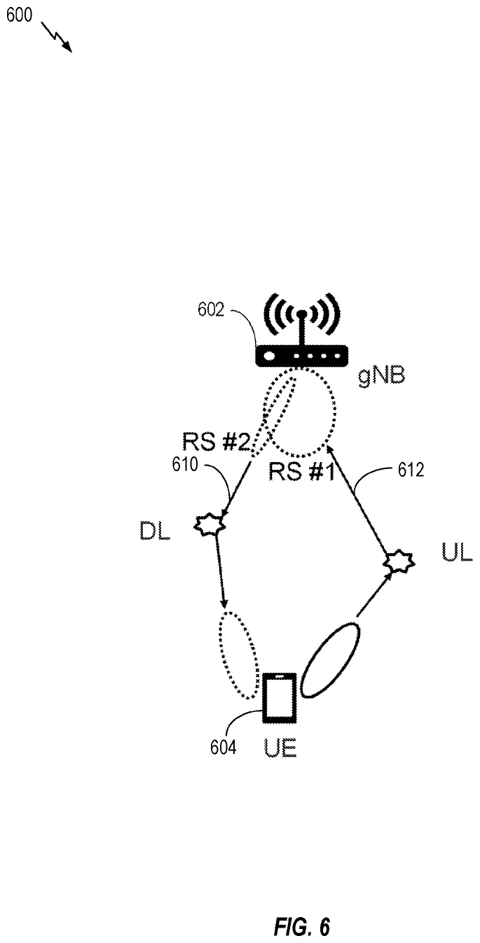

FIG. 6 depicts an example of a UE 604 communicating with a network entity 602 via decoupled UL and DL beams, in accordance with aspects of the present disclosure. The network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. In the example, for the TCI with DL RS #1 as a quasi-collocated (QCL) source, the UE may receive via beam 610 and transmit via beam 612, if UL transmit power on beam 610 is limited by MPE. For the same TCI, the network entity may transmit via the beam 610, in order to reduce a number of configured TCI states, for example. However, the network entity may not be able to receive via beam 612 when the network entity is configured to use the beam 610.

According to aspects of the present disclosure, it is desirable to provide techniques for informing a network entity (e.g., a gNB) that receive and transmit beams used by a UE are the same or different for the same reference signal, so that the network entity will decide to use the same or different beam for receiving as the beam used for transmitting the QCL source RS on which the transmit beam used by the UE is based.

### Example Operations of Entities in a Communications Network

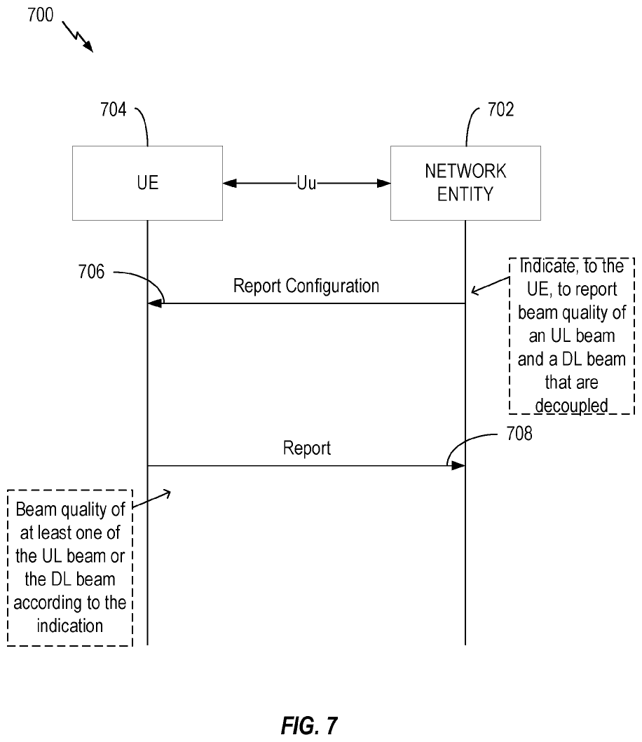

FIG. 7 depicts a call flow 700 for communications in a network between a network entity 702 and a user equipment (UE) 704. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 104 may be another type of wireless communications device and BS 102 may be another type of network entity or network node, such as those described herein.

As illustrated, at 706, the network entity sends a report configuration to the UE configuring the UE to report beam quality of an uplink (UL) beam and a downlink (DL) beam that are decoupled. The network entity sending the report configuration is an example of the network entity sending an indication to report beam quality of an UL beam and a DL beam that are decoupled. Similarly, the UE receiving the report configuration is an example of the UE obtaining an indication to report beam quality of an UL beam and a DL beam that are decoupled. At 708, the UE reports and the network entity receives a report configured per the configuration. The network entity receiving the report is an example of a network entity receiving a report of a beam quality of at least one of the UL beam or the DL beam according to the indication. Similarly, the UE transmitting the report is an example of the UE reporting a beam quality of at least one of the UL beam or the DL beam according to the indication.

According to aspects of the present disclosure, a network entity can configure three types of beam reports for UEs to use when reporting beam qualities for decoupled DL and UL TCIs. The three types of beam reports can include a DL only beam report, an UL only beam report, or a joint DL and UL beam report. The three types of beam reports can be indicated, for example, in a CSI-ReportConfig information element (IE). A network entity configuring one or more of these types of beam reports is an example of the network entity sending an indication to report beam quality of an UL beam and a DL beam that are decoupled, as shown at 706 in FIG. 7. Similarly, a UE receiving a configuration of one or more of these types of beam reports is an example of the UE obtaining an indication to report beam quality of an UL beam and a DL beam that are decoupled, as shown at 706 in FIG. 7.

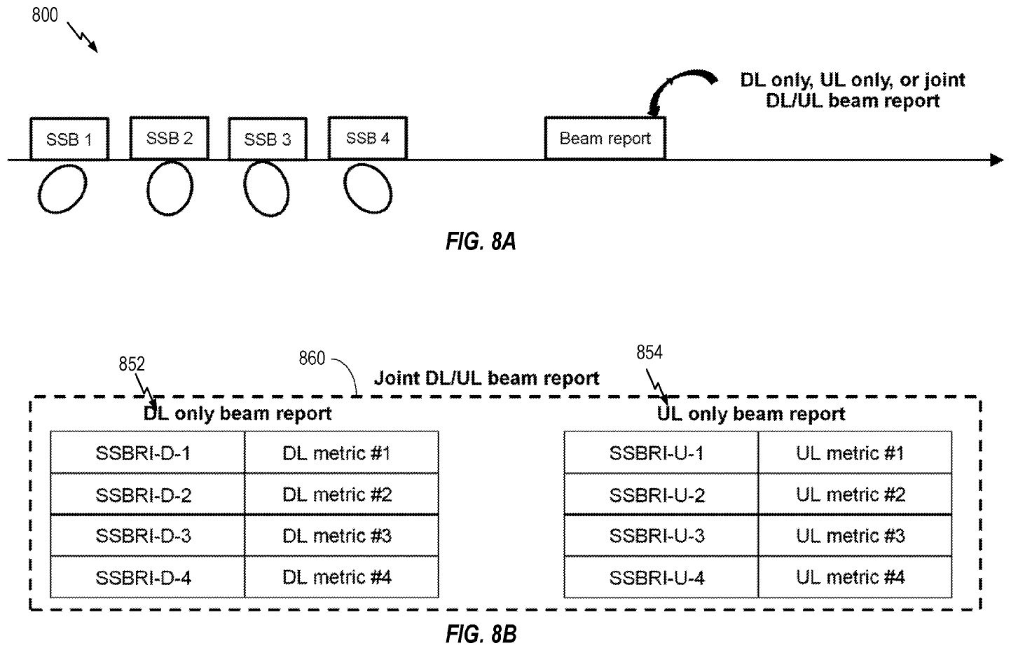

FIG. 8A depicts an example timeline 800 of a synchronization signal block (SSB) based P1 beam management procedure, in accordance with aspects of the present disclosure. In the example timeline, a network entity transmits SSB via four different beams, depicted as SSB 1, SSB 2, SSB 3, and SSB 4. Later, the UE transmits a beam report that may be a DL only beam report, an UL only beam report, or a joint DL and UL beam report.

FIG. 8B depicts in block form example beam reports that the UE might transmit in the timeline 800, according to aspects of the present disclosure. As illustrated, a DL only beam report 852 includes a column of SSB resource identifiers for the downlink beams, referred to as SSBRI-D-1, SSBRI-D-2, SSBRI-D-3, and SSBRI-D-4. For each of the SSB resource identifiers for the DL beams, there is a corresponding DL beam metric in the same row. As illustrated, an UL only beam report 854 includes a column of SSB resource identifiers for the uplink beams, referred to as SSBRI-U-1, SSBRI-U-2, SSBRI-U-3, and SSBRI-U-4. For each of the SSB resource identifiers for the UL beams, there is a corresponding UL beam metric in the same row. As illustrated, a joint DL and UL beam report 860 includes all of both the DL only beam report 852 and the UL only beam report 854. A UE transmitting a DL only beam report, an UL only beam report, or a joint DL and UL beam report to a network entity is an example of the UE reporting and the network entity receiving a report of a beam quality of at least one of the UL beam or the DL beam according to the indication, as shown at 708 in FIG. 7.

In aspects of the present disclosure, a UE may inform a network entity whether decoupled DL and UL beams are used by the UE for a given TCI or reported DL RS for decoupled DL and UL beams for a same TCI (i.e. associated with a reference signal). For example, one bit can be used per reported DL RS in a DL beam report to indicate whether decoupled DL and UL beams corresponding to this DL RS are used by the reporting UE. A UE informing a network entity whether decoupled DL and UL beams are used by the UE for a given TCI or reported DL RS is an example of the UE reporting and the network entity receiving a report of a beam quality of at least one of the UL beam or the DL beam according to the indication, as shown at 708 in FIG. 7.

According to aspects of the present disclosure, a UE using decoupled DL and UL beams is an example of the UE obtaining an indication to report beam quality of an UL beam and a DL beam that are decoupled, as shown at 706 in FIG. 7.

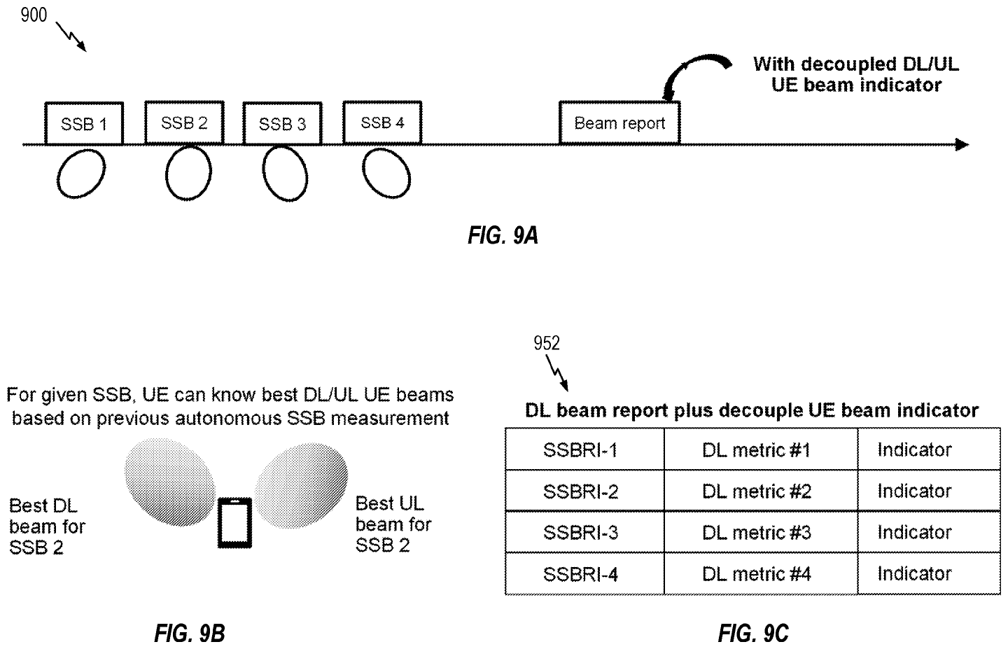

FIG. 9A depicts an example timeline 900 of a synchronization signal block (SSB) based P1 beam management procedure, in accordance with aspects of the present disclosure. In the example timeline, a network entity transmits SSB via four different beams, depicted as SSB 1, SSB 2, SSB 3, and SSB 4. Later, the UE transmits a beam report that may be a DL only beam report, an UL only beam report, or a joint DL and UL beam report.

FIG. 9B depicts the UE, a best DL beam for SSB 2, and a best UL beam for SSB 2, in accordance with aspects of the present disclosure. As illustrated, the UE determines the best DL beam and best UL beam for each SSB based on measurements of SSBs previously transmitted by a network entity.

FIG. 9C depicts in block form an example beam report 952 that the UE might transmit in the timeline 900, according to aspects of the present disclosure. As illustrated, the beam report includes a column of SSB resource identifiers, referred to as SSBRI-1, SSBRI-2, SSBRI-3, and SSBRI-4. For each of the SSB resource identifiers, there is a corresponding DL beam metric and an indicator of whether the UE uses decoupled DL and UL beams for that SSB resource indicator in the same row. A UE transmitting a beam report with indicators of whether the UE uses decoupled DL and UL beams is an example of the UE reporting and the network entity receiving a report of a beam quality of at least one of the UL beam or the DL beam according to the indication, as shown at 708 in FIG. 7.

In aspects of the present disclosure, a UE may report both DL and UL metrics per reported RS for decoupled DL and UL beams for a same TCI. A network entity receiving such a report may select a TCI jointly considering both the DL metrics and the UL metrics. In addition, an indicator that the UE uses decoupled DL and UL beams per reported RS can also be signaled. A UE including an indicator of using decoupled DL and UL beams for a reported DL RS in a beam report to a network entity is an example of the UE reporting and the network entity receiving a report of a beam quality of at least one of the UL beam or the DL beam according to the indication, as shown at 708 in FIG. 7.

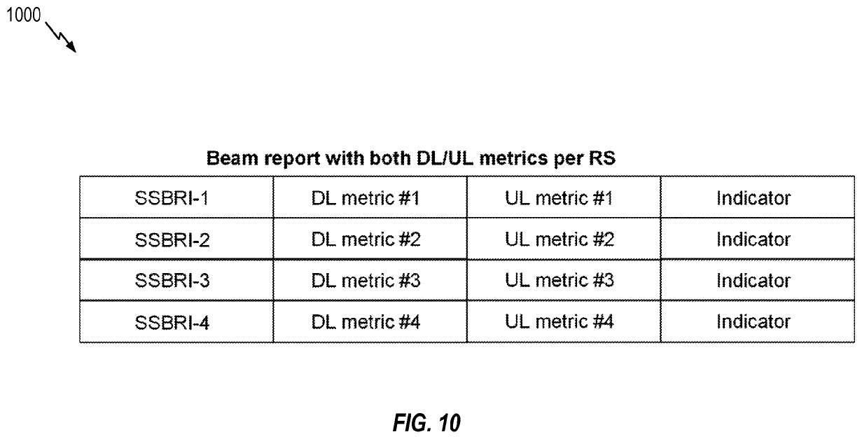

FIG. 10 depicts in block form an example beam report 1002 that the UE may transmit in the timeline 900 shown in FIG. 9A, according to aspects of the present disclosure. As illustrated, the beam report includes a column of SSB resource identifiers, referred to as SSBRI-1, SSBRI-2, SSBRI-3, and SSBRI-4. For each of the SSB resource identifiers, there is a corresponding DL beam metric, a corresponding UL beam metric, and an indicator of whether the UE uses decoupled DL and UL beams for that SSB resource indicator in the same row. A UE transmitting a beam report with indicators of whether the UE uses decoupled DL and UL beams is an example of the UE reporting and the network entity receiving a report of a beam quality of at least one of the UL beam or the DL beam according to the indication, as shown at 708 in FIG. 7.

According to aspects of the present disclosure, a DL metric may include one or more of a layer 1 RSRP (L1-RSRP), a layer 1 signal-to-interference-and-noise ratio (L1-SINR), a DL throughput, a channel quality indicator (CQI), a rank indicator (RI), or a precoding matrix indicator (PMI).

In aspects of the present disclosure, an UL metric may include one or more of UL RSRP, a power management maximum power reduction (P-MPR), a virtual power headroom (vPHR), a power head room (PHR), or a maximum transmit power of the UE for the frequency band.

According to aspects of the present disclosure, a network entity (e.g., a gNB or a BS, such as BS 102, shown in FIGS. 1 and 3) may configure a UE with separate periodic or semi-persistent DL only and UL only beam reports when configuring the UE to make beam reports for a P2 beam management procedure for decoupled DL/UL TCIs. A network entity configuring a UE to make such DL only and UL only beam reports is an example of the network entity sending an indication to report beam quality of an UL beam and a DL beam that are decoupled, as shown at 706 in FIG. 7. Similarly, a UE receiving a configuration to make such DL only and UL only beam reports is an example of the UE obtaining an indication to report beam quality of an UL beam and a DL beam that are decoupled, as shown at 706 in FIG. 7.

In aspects of the present disclosure, a network entity (e.g., a gNB or a BS, such as BS 102, shown in FIGS. 1 and 3) may configure one periodic or semi-persistent CSI-RS resource set, which can be alternatively measured by a UE using decoupled DL and UL beams to supply measurements to the network entity to use to select a beam(s) during a periodic or semi-persistent CSI-RS based P2 beam management procedure for same TCIs with decoupled DL and UL beams.

According to aspects of the present disclosure, a network entity (e.g., a gNB or a BS, such as BS 102, shown in FIGS. 1 and 3) may configure a UE with separate periodic or semi-persistent DL only and UL only CSI-RS for a P3 beam management procedure when performing a periodic or semi-persistent CSI-RS based P2 beam management procedure for decoupled DL and UL TCIs.

In aspects of the present disclosure, a network entity (e.g., a gNB or a BS, such as BS 102, shown in FIGS. 1 and 3) may configure one periodic or semi-persistent CSI-RS resource set, which can be used alternatively for measuring a DL receive beam in a P3 beam management procedure or for measuring an UL transmit beam for UL beam refinement in a periodic or semi-persistent CSI-RS based P2 beam management procedure for a same TCI with decoupled DL and UL beams.

According to aspects of the present disclosure, a network entity (e.g., a gNB or a BS, such as BS 102, shown in FIGS. 1 and 3) may configure three types of beam reports for a UE to report beam measurements for a P2 beam management procedure for decoupled DL and UL TCIs. The three types of beam reports can include a DL only report, an UL only report, or a joint DL beam and UL beam report. The network entity can include the type of report in a CSI-ReportConfig IE, for example. A network entity configuring a UE to make one of the three types of beam reports is an example of the network entity sending an indication to report beam quality of an UL beam and a DL beam that are decoupled, as shown at 706 in FIG. 7. Similarly, a UE receiving a configuration to make one of the three types of beam reports is an example of the UE obtaining an indication to report beam quality of an UL beam and a DL beam that are decoupled, as shown at 706 in FIG. 7.

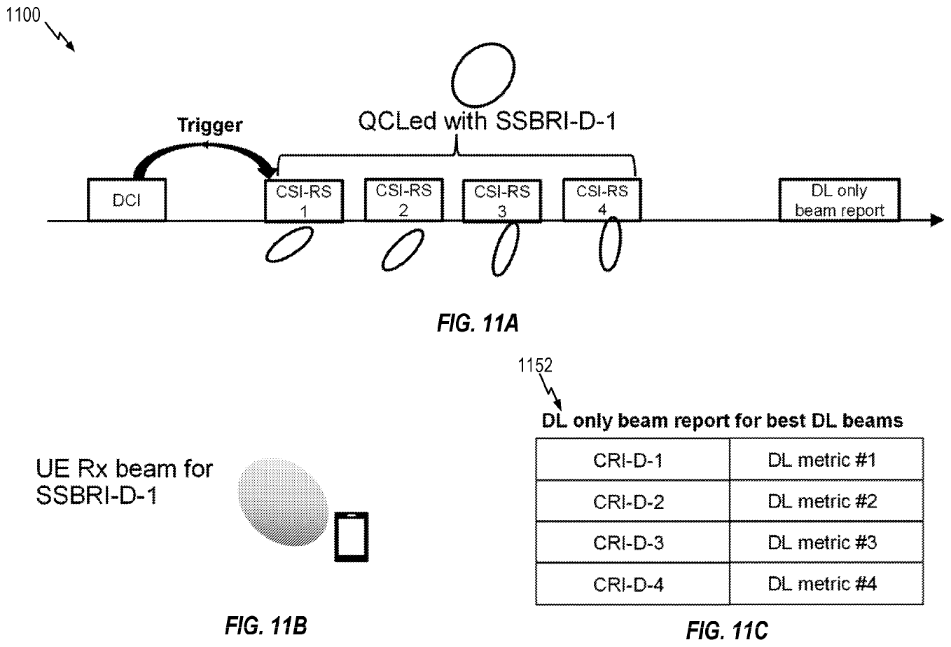

FIG. 11A depicts an example timeline 1100 of a P2 beam management procedure, according to aspects of the present disclosure. In the example timeline, a network entity triggers a DL only P2 beam report based on aperiodic CSI-RSs to cause a UE to identify a best DL P2 beam within a DL P1 SSB beam selected by the network entity, for example, the DL P1 beam having identifier SSBRI-D-1. The network entity transmits CSI-RS, quasi-collocated with SSBRI-D-1, via four different beams, depicted as CSI-RS 1, CSI-RS 2, CSI-RS 3, and CSI-RS 4. Later, the UE transmits a DL only beam report, based on the CSI-RS.

FIG. 11B depicts the UE and the receive beam of the UE associated with SSBRI-D-1, in accordance with aspects of the present disclosure. As illustrated, the UE measures the CSI-RS transmitted by the network entity as received by the UE using the depicted receive beam.

FIG. 11C depicts in block form an example DL only beam report 1152 that the UE may transmit in the timeline 1100, according to aspects of the present disclosure. As illustrated, the beam report includes a column of CSI-RS resource identifiers, referred to as CRI-D-1, CRI-D-2, CRI-D-3, and CRI-D-4. For each of the CSI-RS resource identifiers, there is a corresponding DL beam metric in the same row. A UE transmitting such a DL only beam report is an example of the UE reporting and the network entity receiving a report of a beam quality of at least one of the UL beam or the DL beam according to the indication, as shown at 708 in FIG. 7.

In aspects of the present disclosure, a network entity (e.g., a gNB or a BS, such as BS 102, shown in FIGS. 1 and 3) may trigger an UL only P2 beam report based on AP CSI-RSs to identify a best UL P2 beam within an UL P1 SSB beam selected by the network entity, for decoupled DL/UL TCIs.

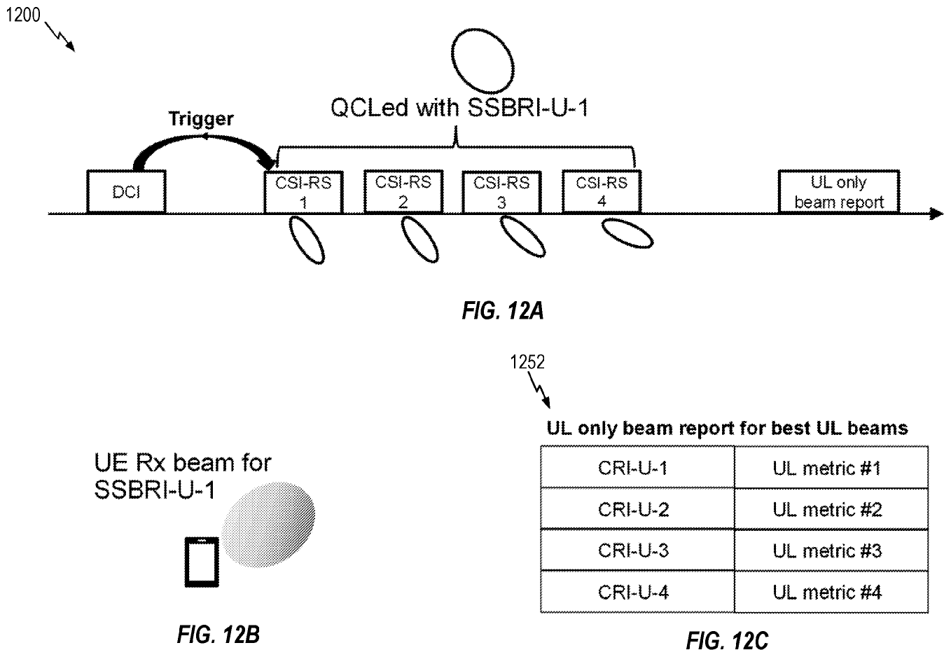

FIG. 12A depicts an example timeline 1100 of a P2 beam management procedure, according to aspects of the present disclosure. In the example timeline, a network entity triggers an UL only P2 beam report based on aperiodic CSI-RSs to cause a UE to identify a best UL P2 beam within an UL P1 SSB beam selected by the network entity, for example, the UL P1 beam having identifier SSBRI-U-1. The network entity transmits CSI-RS, quasi-collocated with SSBRI-U-1, via four different beams, depicted as CSI-RS 1, CSI-RS 2, CSI-RS 3, and CSI-RS 4. Later, the UE transmits an UL only beam report, based on the CSI-RS.

FIG. 12B depicts the UE and the receive beam of the UE associated with SSBRI-U-1, in accordance with aspects of the present disclosure. As illustrated, the UE measures the CSI-RS transmitted by the network entity as received by the UE using the depicted receive beam.

FIG. 12C depicts in block form an example UL only beam report 1252 that the UE may transmit in the timeline 1200, according to aspects of the present disclosure. As illustrated, the beam report includes a column of CSI-RS resource identifiers, referred to as CRI-D-1, CRI-D-2, CRI-D-3, and CRI-D-4. For each of the CSI-RS resource identifiers, there is a corresponding UL beam metric in the same row. A UE transmitting such an UL only beam report is an example of the UE reporting and the network entity receiving a report of a beam quality of at least one of the UL beam or the DL beam according to the indication, as shown at 708 in FIG. 7.

According to aspects of the present disclosure, a network entity (e.g., a gNB or a BS, such as BS 102, shown in FIGS. 1 and 3) may trigger transmission of two aperiodic CSI-RS resource sets, with the second set being a repetition of the first set for a P2 CSI-RS beam report. In such a case, the first and second sets are respectively measured by a UE using a best DL and a best UL beams for a P1 SSB beam selected by the network entity for the DL and UL beam measurement.

For a UE that supports simultaneous two-beam measurement, the network entity may trigger transmission of a single aperiodic CSI-RS resource set, and the UE can measure the single set of aperiodic CSI-RS with both a DL beam and a UL beam and then report the best DL and best UL beams.

In aspects of the present disclosure, a UE selects a P2 CSI-RS beam as a potential TCI for both DL and UL by jointly considering the DL metric of the P2 CSI-RS beam as measured by the best DL beam of the P1 SSB beam selected by the network entity and the UL metric as measured by the best UL beam of the same P1 SSB beam. For example, a UE may report as a best CSI-RS beam a CSI-RS beam having a best DL RSRP among all CSI-RS beams that have an UL RSRP exceeding a minimum threshold.

According to aspects of the present disclosure, a network entity (e.g., a gNB or a BS, such as BS 102, shown in FIGS. 1 and 3) may trigger two sets of AP CSI-RS resource sets for DL and UL metric measurement if:
1) The SSBRI-1 has decoupled UE DL/UL beams as indicated in the P1 report; and
2) the UE does not support one RS simultaneously measured by two receive beams

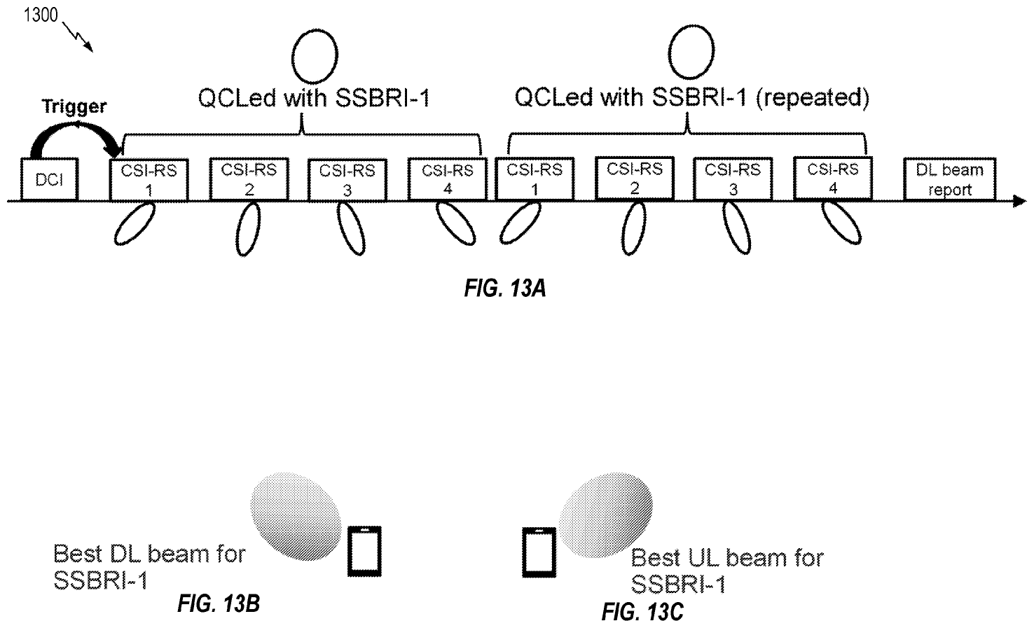

FIG. 13A depicts an example timeline 1300 of a P2 beam management procedure, according to aspects of the present disclosure. In the example timeline, a network entity triggers a P2 beam report based on aperiodic CSI-RSs to cause a UE to identify a best DL P2 beam and a best UL P2 beam within an UL P1 SSB beam selected by the network entity, for example, the DL Pl and UL P1 beams having identifier SSBRI-1. The network entity transmits a first set of CSI-RS, quasi-collocated with SSBRI-1, via four different beams, depicted as CSI-RS 1, CSI-RS 2, CSI-RS 3, and CSI-RS 4. The UE measures the CSI-RS in the first set using the best DL beam associated with SSBRI-1, shown in FIG. 13B. Next, the network transmits a second set of CSI-RS, quasi-collocated with SSBRI-1 and via the same four beams used in transmitting the CSI-RS in the first set. The UE measures the CSI-RS in the second set using the best UL beam associated with SSBRI-1, shown in FIG. 13C. Later, the UE transmits a DL beam report, based on the CSI-RS in the first set and the second set.

FIG. 13B depicts the UE and the best DL beam of the UE associated with SSBRI-1, in accordance with aspects of the present disclosure. The UE measures the CSI-RS transmitted by the network entity in the first set shown in FIG. 13A as received by the UE using the depicted DL beam.

FIG. 13C depicts the UE and the best UL beam of the UE associated with SSBRI-1, in accordance with aspects of the present disclosure. The UE measures the CSI-RS transmitted by the network entity in the second set shown in FIG. 13A as received by the UE using the depicted UL beam.

In aspects of the present disclosure, if a network entity triggers transmission of two sets of CSI-RS, both DL and UL RSRP can be reported per reported CRI. UL RSRP may be calculated as:
UL RSRP=(UL transmit power of UL beam for SSBRI-1-DL transmit power of DL beam for reported CRI)+DL RSRP measured by UL beam for SSBRI-1.

According to aspects of the present disclosure, for each reported CRI, one bit may indicate whether the corresponding UE DL and UL beams are decoupled.

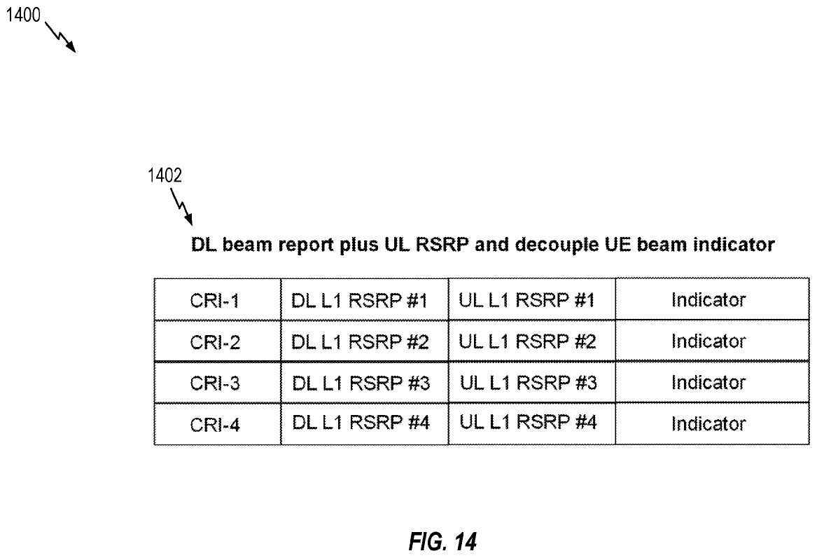

FIG. 14 depicts in block form an example beam report 1402 that the UE may transmit in the timeline 1300 shown in FIG. 13A, according to aspects of the present disclosure. As illustrated, the beam report includes a column of CSI-RS resource identifiers, referred to as CRI-1, CRI-2, CRI-3, and CRI-4. For each of the CSI-RS resource identifiers, there is a corresponding DL RSRP, a corresponding UL RSRP, and an indicator of whether the UE uses decoupled DL and UL beams for that CSI-RS resource indicator in the same row. A UE transmitting a beam report with indicators of whether the UE uses decoupled DL and UL beams is an example of the UE reporting and the network entity receiving a report of a beam quality of at least one of the UL beam or the DL beam according to the indication, as shown at 708 in FIG. 7.

In aspects of the present disclosure, a network entity (e.g., a gNB or a BS, such as BS 102, shown in FIGS. 1 and 3) may configure three types of P3 beam refinement procedures without reports, including DL only P3 beam refinement, UL only P3 beam refinement, or joint DL and UL P3 beam refinement. The network entity may configure the P3 beam refinement by indicating the P3 beam refinement in a CSI-ReportConfig IE, for example.

According to aspects of the present disclosure, for DL only P3 beam refinement, a network entity triggers repetition of a P2 CSI-RS beam for DL selected by the network entity, to refine a DL receive beam within a receive beam for an SSB received with a downlink beam, such as SSBRI-D-1.

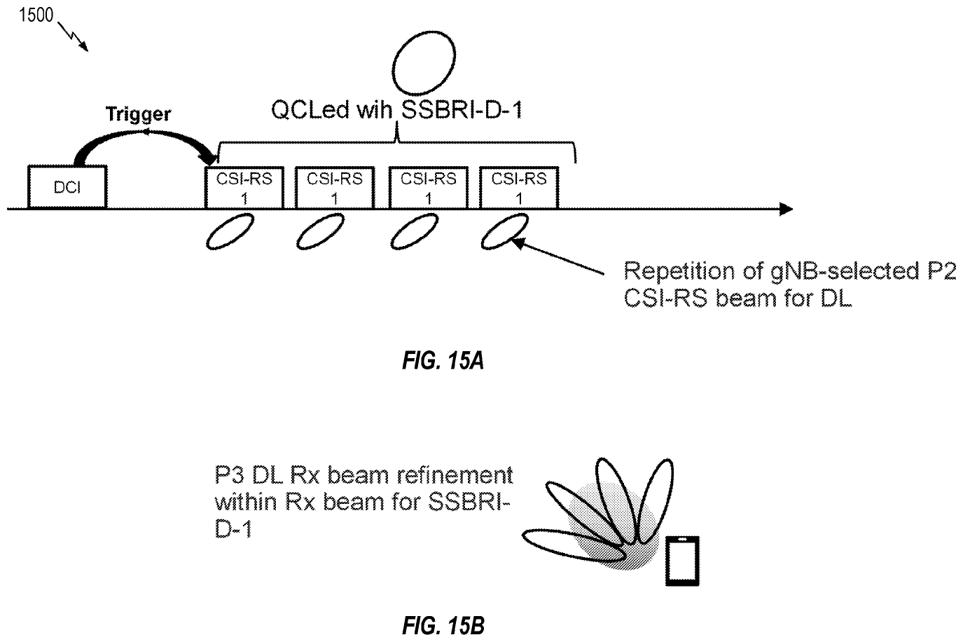

FIG. 15A depicts an example timeline 1500 of a P3 beam refinement procedure without report, according to aspects of the present disclosure. In the example timeline, a network entity triggers a DL only P3 beam refinement based on aperiodic CSI-RSs to cause a UE to refine a best DL P3 beam within a receive beam selected by the network entity, for example, the receive beam for the SSB having identifier SSBRI-D-1. The network entity transmits CSI-RS, quasi-collocated with SSBRI-D-1, via a same beam, depicted as CSI-RS 1, four times.

FIG. 15B depicts the UE and the receive beam of the UE associated with SSBRI-D-1, in accordance with aspects of the present disclosure. As illustrated, the UE refines the P3 DL receive beams using the depicted receive beam.

In aspects of the present disclosure, for UL only P3 beam refinement, a network entity (e.g., a gNB or a BS, such as BS 102, shown in FIGS. 1 and 3) triggers repetition of a P2 CSI-RS beam for UL selected by the network entity, to refine an UL transmit beam within a transmit beam for an SSB received with an UL beam, such as SSBRI-U-1.

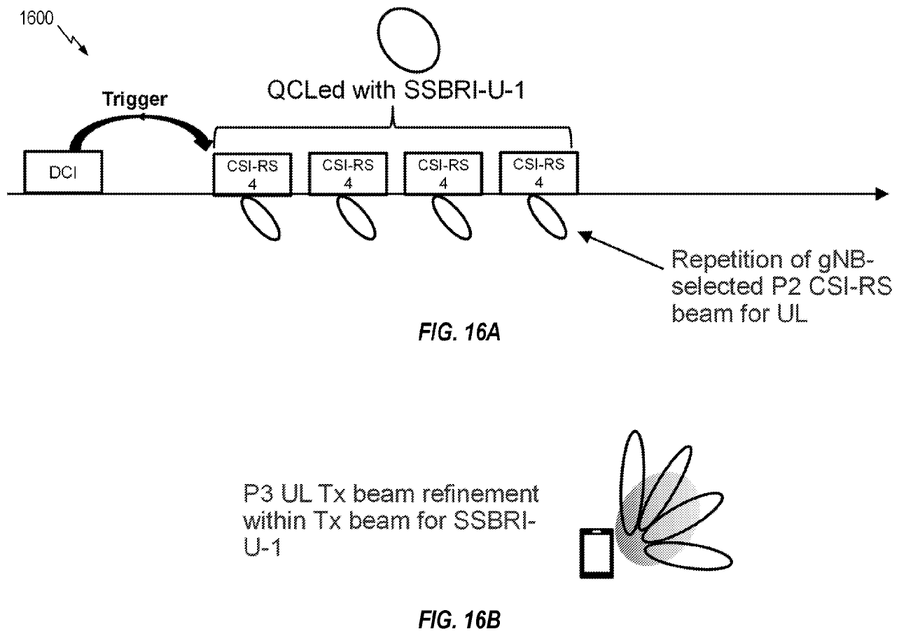

FIG. 16A depicts an example timeline 1600 of a P3 beam refinement procedure without report, according to aspects of the present disclosure. In the example timeline, a network entity triggers an UL only P3 beam refinement based on aperiodic CSI-RSs to cause a UE to refine a best UL P3 beam within a transmit beam selected by the network entity, for example, the transmit beam for the SSB having identifier SSBRI-U-1. The network entity transmits CSI-RS, quasi-collocated with SSBRI-U-1, via a same beam, depicted as CSI-RS 4, four times.

FIG. 16B depicts the UE and the transmit beam of the UE associated with SSBRI-U-1, in accordance with aspects of the present disclosure. As illustrated, the UE refines the P3 UL transmit beams using the depicted transmit beam.

According to aspects of the present disclosure, a network entity (e.g., a gNB or a BS, such as BS 102, shown in FIGS. 1 and 3) may trigger two aperiodic CSI-RS resource sets, with the second set being a repetition of the first set for a P3 CSI-RS beam refinement. In such a case, the first and second sets are respectively used by a UE for refining DL and UL beams for a P2 SSB beam selected by the network entity for the DL and UL P3 beam refinement.

For a UE that supports simultaneous two-beam measurement, the network entity may trigger transmission of a single aperiodic CSI-RS resource set, and the UE can refine DL and UL beams using the single set of aperiodic CSI-RS.

According to aspects of the present disclosure, a network entity (e.g., a gNB or a BS, such as BS 102, shown in FIGS. 1 and 3) may trigger two sets of AP CSI-RS resource sets for DL and UL metric measurement if:
3) The SSBRI-1 has decoupled UE DL and UL beams as indicated in the P1 report; and
4) the UE does not support one RS simultaneously measured by two receive beams

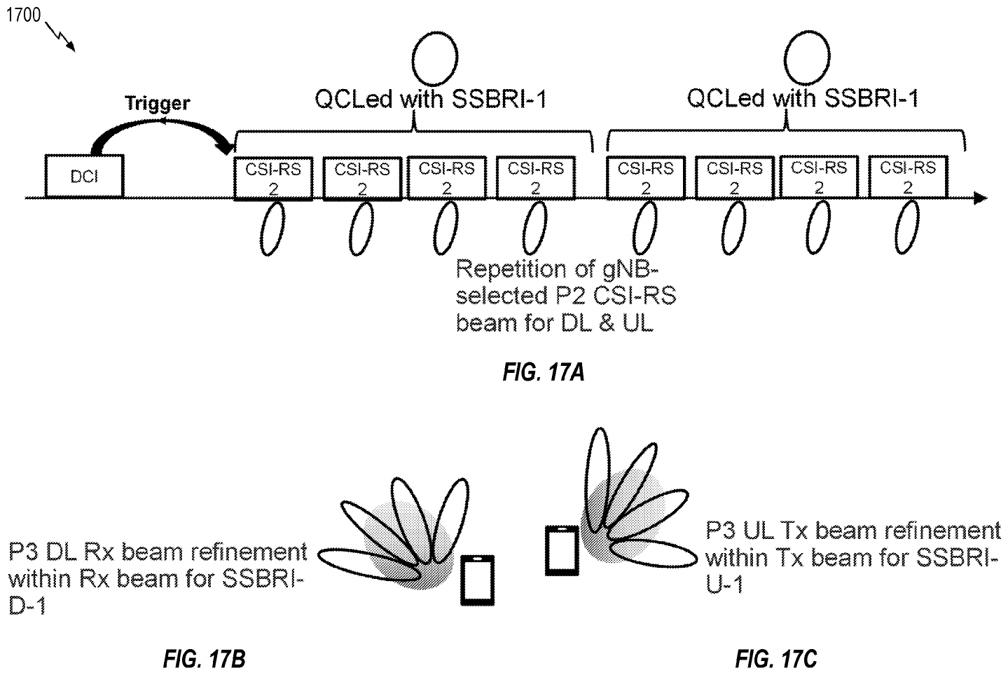

FIG. 17A depicts an example timeline 1700 of a P3 beam refinement procedure, according to aspects of the present disclosure. In the example timeline, a network entity triggers a P3 beam refinement based on aperiodic CSI-RSs to cause a UE to refine a DL P3 beam and an UL P3 beam within an UL and DL SSB beams selected by the network entity, for example, the DL P1 and UL P1 beams having identifier SSBRI-D-1 and SSBRI-U-1. The network entity transmits a first set of four CSI-RS, quasi-collocated with SSBRI-1, via a beam, depicted as CSI-RS 2. The UE refines a receive beam based on the CSI-RS in the first set using the receive beam associated with SSBRI-D-1, shown in FIG. 17B. Next, the network transmits a second set of CSI-RS, quasi-collocated with SSBRI-1 and via the same beam used in transmitting the CSI-RS in the first set. The UE refines a transmit beam based on the CSI-RS in the second set using the transmit beam associated with SSBRI-U-1, shown in FIG. 17C.

FIG. 17B depicts the UE and the receive beam of the UE associated with SSBRI-D-1, in accordance with aspects of the present disclosure. The UE refines the receive beam based on the CSI-RS transmitted by the network entity in the first set shown in FIG. 13A.

FIG. 17C depicts the UE and the transmit beam of the UE associated with SSBRI-U-1, in accordance with aspects of the present disclosure. The UE refines the transmit beam based on the CSI-RS transmitted by the network entity in the second set shown in FIG. 13A.

### Example Operations of a User Equipment

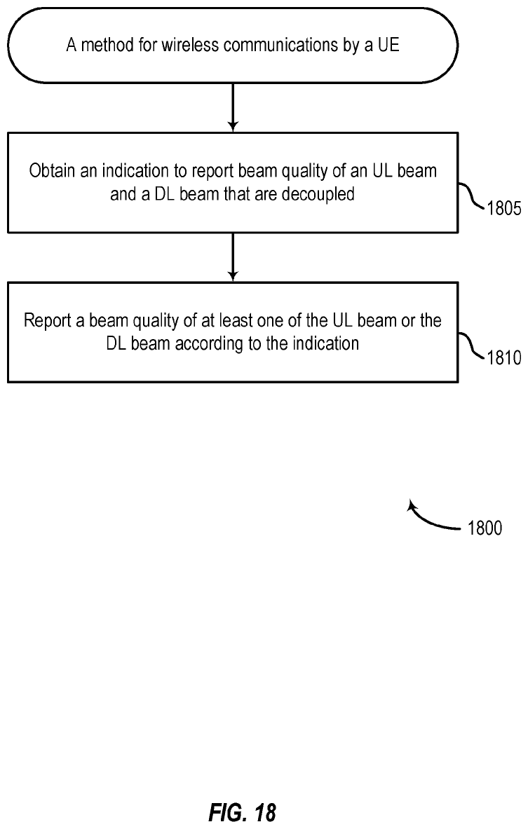

FIG. 18 shows an example of a method 1800 for wireless communications by a UE, such as a UE 104 of FIGS. 1 and 3.

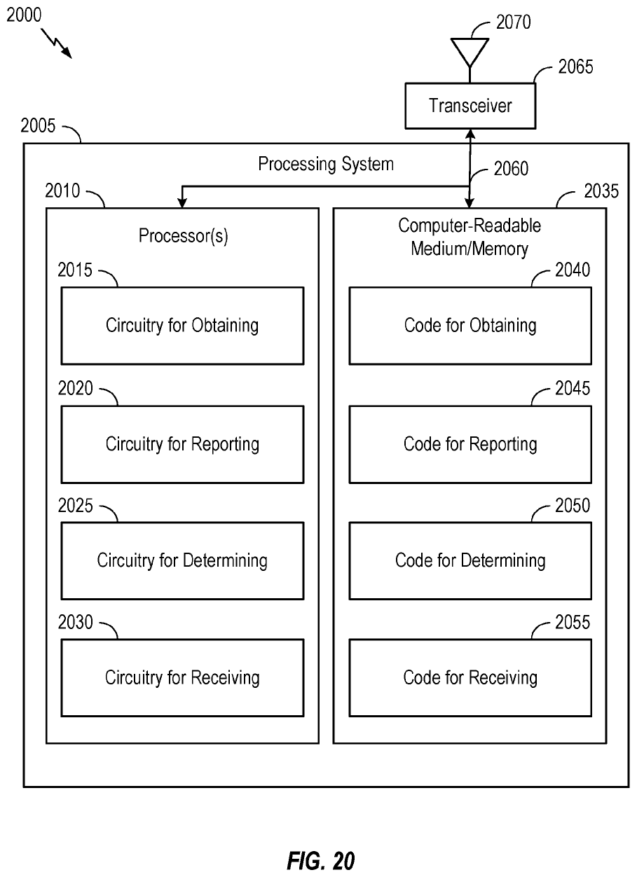

Method 1800 begins at step 1805 with obtaining an indication to report beam quality of an UL beam and a DL beam that are decoupled. In some cases, the operations of this step refer to, or may be performed by, circuitry for obtaining and/or code for obtaining as described with reference to FIG. 20.

Method 1800 then proceeds to step 1810 with reporting a beam quality of at least one of the UL beam or the DL beam according to the indication. In some cases, the operations of this step refer to, or may be performed by, circuitry for reporting and/or code for reporting as described with reference to FIG. 20.

In some aspects, obtaining the indication comprises receiving a configuration to report a first quality metric of the DL beam or a second quality metric of the UL beam; and reporting the beam quality comprises transmitting a report according to the configuration.

In some aspects, the configuration configures the UE to report only the first quality metric of the DL beam.

In some aspects, the configuration configures the UE to report only the second quality metric of the UL beam.

In some aspects, the configuration configures the UE to report the first quality metric of the DL beam and the second quality metric of the UL beam.

In some aspects, the method 1800 further includes determining the first quality metric based on a first periodic or semi-persistently scheduled CSI-RS. In some cases, the operations of this step refer to, or may be performed by, circuitry for determining and/or code for determining as described with reference to FIG. 20.

In some aspects, the method 1800 further includes determining the second quality metric based on a second periodic or semi-persistently scheduled CSI-RS that is different from the first periodic or semi-persistently scheduled CSI-RS. In some cases, the operations of this step refer to, or may be performed by, circuitry for determining and/or code for determining as described with reference to FIG. 20.

In some aspects, the method 1800 further includes receiving a configuration of the first periodic or semi-persistently scheduled CSI-RS and the second periodic or semi-persistently scheduled CSI-RS. In some cases, the operations of this step refer to, or may be performed by, circuitry for receiving and/or code for receiving as described with reference to FIG. 20.

In some aspects, the method 1800 further includes determining the first quality metric or the second quality metric based on an aperiodic CSI-RS. In some cases, the operations of this step refer to, or may be performed by, circuitry for determining and/or code for determining as described with reference to FIG. 20.

In some aspects, the method 1800 further includes determining the first quality metric based on a first aperiodic CSI-RS. In some cases, the operations of this step refer to, or may be performed by, circuitry for determining and/or code for determining as described with reference to FIG. 20.

In some aspects, the method 1800 further includes determining the second quality metric based on a second aperiodic CSI-RS that is a repetition of the first aperiodic CSI-RS. In some cases, the operations of this step refer to, or may be performed by, circuitry for determining and/or code for determining as described with reference to FIG. 20.

In some aspects, the method 1800 further includes determining the first quality metric based on an aperiodic CSI-RS. In some cases, the operations of this step refer to, or may be performed by, circuitry for determining and/or code for determining as described with reference to FIG. 20.

In some aspects, the method 1800 further includes determining the second quality metric based on the aperiodic CSI-RS. In some cases, the operations of this step refer to, or may be performed by, circuitry for determining and/or code for determining as described with reference to FIG. 20.

In some aspects, obtaining the indication comprises transmitting an UL signal via the UL beam to a network entity and receiving, from the network entity, a DL signal via the DL beam.

In some aspects, reporting the beam quality comprises transmitting a report comprising a quality metric of the DL beam and an indicator that the UL beam is decoupled from the DL beam.

In some aspects, reporting the beam quality comprises transmitting a report comprising a first quality metric of the DL beam, a second quality metric of the UL beam, and an indicator that the UL beam is decoupled from the DL beam.

In some aspects, the method 1800 further includes determining a first quality metric of the DL beam based on a periodic or semi-persistently scheduled CSI-RS received at a first time. In some cases, the operations of this step refer to, or may be performed by, circuitry for determining and/or code for determining as described with reference to FIG. 20.

In some aspects, the method 1800 further includes determining a second quality metric of the UL beam based on the periodic or semi-persistently scheduled CSI- RS received at a second time that is different from the first time. In some cases, the operations of this step refer to, or may be performed by, circuitry for determining and/or code for determining as described with reference to FIG. 20.

In some aspects, the method 1800 further includes determining the first quality metric based on a first aperiodic CSI-RS. In some cases, the operations of this step refer to, or may be performed by, circuitry for determining and/or code for determining as described with reference to FIG. 20.

In some aspects, the method 1800 further includes determining the second quality metric based on a second aperiodic CSI-RS that is a repetition of the first aperiodic CSI-RS. In some cases, the operations of this step refer to, or may be performed by, circuitry for determining and/or code for determining as described with reference to FIG. 20.

In some aspects, the method 1800 further includes determining the first quality metric based on an aperiodic CSI-RS. In some cases, the operations of this step refer to, or may be performed by, circuitry for determining and/or code for determining as described with reference to FIG. 20.

In some aspects, the method 1800 further includes determining the second quality metric based on the aperiodic CSI-RS. In some cases, the operations of this step refer to, or may be performed by, circuitry for determining and/or code for determining as described with reference to FIG. 20.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

### Example Operations of a Network Entity

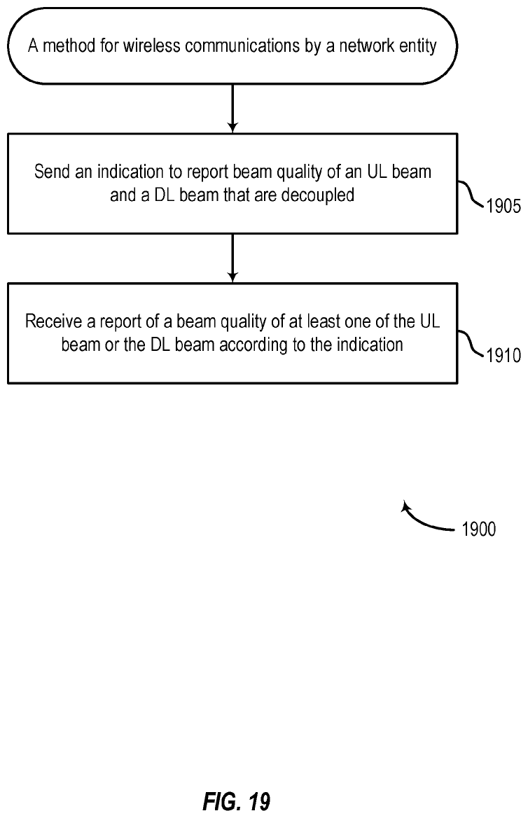

FIG. 19 shows an example of a method 1900 for wireless communications by a network entity, such as a BS 102 of FIGS. 1 and 3, or a disaggregated base station as discussed with respect to FIG. 2.

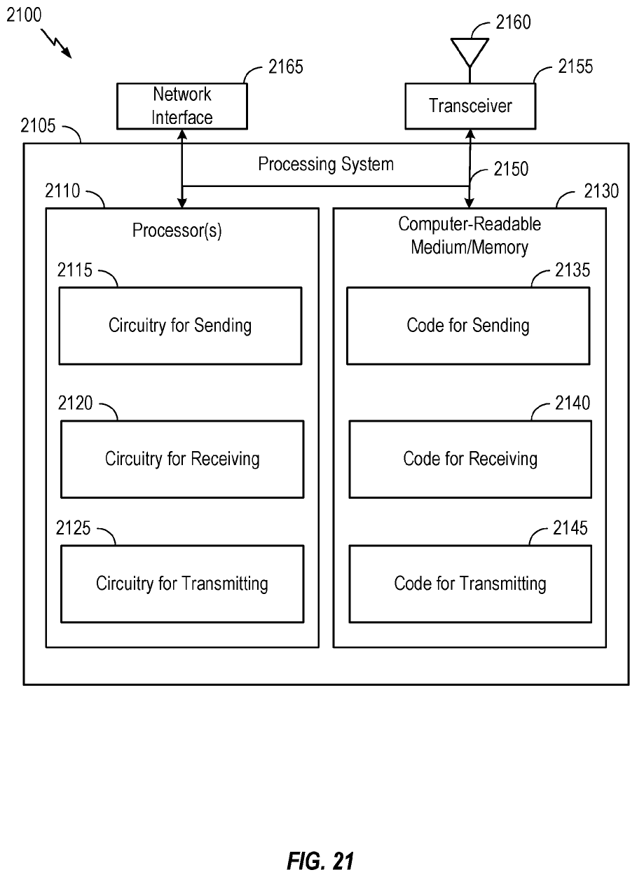

Method 1900 begins at step 1905 with sending an indication to report beam quality of an UL beam and a DL beam that are decoupled. In some cases, the operations of this step refer to, or may be performed by, circuitry for sending and/or code for sending as described with reference to FIG. 21.

Method 1900 then proceeds to step 1910 with receiving a report of a beam quality of at least one of the UL beam or the DL beam according to the indication. In some cases, the operations of this step refer to, or may be performed by, circuitry for receiving and/or code for receiving as described with reference to FIG. 21.

In some aspects, sending the indication comprises transmitting a configuration to report a first quality metric of the DL beam or a second quality metric of the UL beam; and receiving the report comprises receiving the report according to the configuration.

In some aspects, the configuration configures a UE to report only the first quality metric of the DL beam.

In some aspects, the configuration configures a UE to report only the second quality metric of the UL beam.

In some aspects, the configuration configures a UE to report the first quality metric of the DL beam and the second quality metric of the UL beam.

In some aspects, the first quality metric is based on a first periodic or semi-persistently scheduled CSI-RS; and the second quality metric is based on a second periodic or semi-persistently scheduled CSI-RS that is different from the first periodic or semi-persistently scheduled CSI-RS.

In some aspects, the method 1900 further includes transmitting a configuration of the first periodic or semi-persistently scheduled CSI-RS and the second periodic or semi-persistently scheduled CSI-RS. In some cases, the operations of this step refer to, or may be performed by, circuitry for transmitting and/or code for transmitting as described with reference to FIG. 21.

In some aspects, the first quality metric or the second quality metric is based on an aperiodic CSI-RS.

In some aspects, the first quality metric is based on a first aperiodic CSI-RS; and the second quality metric is based on a second aperiodic CSI-RS that is a repetition of the first aperiodic CSI-RS.

In some aspects, the first quality metric is based on an aperiodic CSI-RS; and the second quality metric is based on the aperiodic CSI-RS.

In some aspects, sending the indication comprises receiving an UL signal via the UL beam and transmitting a DL signal via the DL beam.

In some aspects, the report comprises a quality metric of the DL beam and an indicator that the UL beam is decoupled from the DL beam.

In some aspects, the report comprises a first quality metric of the DL beam, a second quality metric of the UL beam, and an indicator that the UL beam is decoupled from the DL beam.

In some aspects, a first quality metric of the DL beam is based on a periodic or semi-persistently scheduled CSI-RS transmitted at a first time; and a second quality metric of the UL beam is based on the periodic or semi-persistently scheduled CSI-RS transmitted at a second time that is different from the first time.

In some aspects, the first quality metric is based on a first aperiodic CSI-RS; and the second quality metric is based on a second aperiodic CSI-RS that is a repetition of the first aperiodic CSI-RS.

In some aspects, the first quality metric is based on an aperiodic CSI-RS; and the second quality metric is based on the aperiodic CSI-RS.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative steps are possible consistent with this disclosure.

### Example Communications Devices

FIG. 20 depicts aspects of an example communications device 2000. In some aspects, communications device 2000 is a user equipment, such as a UE 104 described above with respect to FIGS. 1 and 3.

The communications device 2000 includes a processing system 2005 coupled to the transceiver 2065 (e.g., a transmitter and/or a receiver). The transceiver 2065 is configured to transmit and receive signals for the communications device 2000 via the antenna 2070, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. The one or more processors 2010 are coupled to a computer-readable medium/memory 2035 via a bus 2060. In certain aspects, the computer-readable medium/memory 2035 is configured to store instructions (e.g., computer-executable code) that when executed by the one or more processors 2010, cause the one or more processors 2010 to perform the method 1800 described with respect to FIG. 18, or any aspect related to it. Note that reference to a processor performing a function of communications device 2000 may include one or more processors 2010 performing that function of communications device 2000.

In the depicted example, computer-readable medium/memory 2035 stores code (e.g., executable instructions), such as code for obtaining 2040, code for reporting 2045, code for determining 2050, and code for receiving 2055. Processing of the code for obtaining 2040, code for reporting 2045, code for determining 2050, and code for receiving 2055 may cause the communications device 2000 to perform the method 1800 described with respect to FIG. 18, or any aspect related to it.

The one or more processors 2010 include circuitry configured to implement (e.g., execute) the code stored in the computer-readable medium/memory 2035, including circuitry such as circuitry for obtaining 2015, circuitry for reporting 2020, circuitry for determining 2025, and circuitry for receiving 2030. Processing with circuitry for obtaining 2015, circuitry for reporting 2020, circuitry for determining 2025, and circuitry for receiving 2030 may cause the communications device 2000 to perform the method 1800 described with respect to FIG. 18, or any aspect related to it.

Various components of the communications device 2000 may provide means for performing the method 1800 described with respect to FIG. 18, or any aspect related to it. For example, means for transmitting, sending or outputting for transmission may include transceivers 354 and/or antenna(s) 352 of the UE 104 illustrated in FIG. 3 and/or the transceiver 2065 and the antenna 2070 of the communications device 2000 in FIG. 20. Means for receiving or obtaining may include transceivers 354 and/or antenna(s) 352 of the UE 104 illustrated in FIG. 3 and/or the transceiver 2065 and the antenna 2070 of the communications device 2000 in FIG. 20.

FIG. 21 depicts aspects of an example communications device 2100. In some aspects, communications device 2100 is a network entity, such as a BS 102 of FIGS. 1 and 3, or a disaggregated base station as discussed with respect to FIG. 2.

The communications device 2100 includes a processing system 2105 coupled to the transceiver 2155 (e.g., a transmitter and/or a receiver) and/or a network interface 2165. The transceiver 2155 is configured to transmit and receive signals for the communications device 2100 via the antenna 2160, such as the various signals as described herein. The network interface 2165 is configured to obtain and send signals for the communications device 2100 via communication link(s), such as a backhaul link, midhaul link, and/or fronthaul link as described herein, such as with respect to FIG. 2. The processing system 2105 may be configured to perform processing functions for the communications device 2100, including processing signals received and/or to be transmitted by the communications device 2100.

The processing system 2105 includes one or more processors 2110. In various aspects, one or more processors 2110 may be representative of one or more of receive processor 338, transmit processor 320, TX MIMO processor 330, and/or controller/processor 340, as described with respect to FIG. 3. The one or more processors 2110 are coupled to a computer-readable medium/memory 2130 via a bus 2150. In certain aspects, the computer-readable medium/memory 2130 is configured to store instructions (e.g., computer-executable code) that when executed by the one or more processors 2110, cause the one or more processors 2110 to perform the method 1900 described with respect to FIG. 19, or any aspect related to it. Note that reference to a processor of communications device 2100 performing a function may include one or more processors 2110 of communications device 2100 performing that function.

In the depicted example, the computer-readable medium/memory 2130 stores code (e.g., executable instructions), such as code for sending 2135, code for receiving 2140, and code for transmitting 2145. Processing of the code for sending 2135, code for receiving 2140, and code for transmitting 2145 may cause the communications device 2100 to perform the method 1900 described with respect to FIG. 19, or any aspect related to it.

The one or more processors 2110 include circuitry configured to implement (e.g., execute) the code stored in the computer-readable medium/memory 2130, including circuitry such as circuitry for sending 2115, circuitry for receiving 2120, and circuitry for transmitting 2125. Processing with circuitry for sending 2115, circuitry for receiving 2120, and circuitry for transmitting 2125 may cause the communications device 2100 to perform the method 1900 as described with respect to FIG. 19, or any aspect related to it.

Various components of the communications device 2100 may provide means for performing the method 1900 as described with respect to FIG. 19, or any aspect related to it. Means for transmitting, sending or outputting for transmission may include transceivers 332 and/or antenna(s) 334 of the BS 102 illustrated in FIG. 3 and/or the transceiver 2155 and the antenna 2160 of the communications device 2100 in FIG. 21. Means for receiving or obtaining may include transceivers 332 and/or antenna(s) 334 of the BS 102 illustrated in FIG. 3 and/or the transceiver 2155 and the antenna 2160 of the communications device 2100 in FIG. 21.

### Example Clauses

Implementation examples are described in the following numbered clauses:
Clause 1: A method for wireless communications by a UE, comprising: obtaining an indication to report beam quality of an UL beam and a DL beam that are decoupled; and reporting a beam quality of at least one of the UL beam or the DL beam according to the indication.
Clause 2: The method of Clause 1, wherein: obtaining the indication comprises receiving a configuration to report a first quality metric of the DL beam or a second quality metric of the UL beam; and reporting the beam quality comprises transmitting a report according to the configuration.
Clause 3: The method of Clause 2, wherein the configuration configures the UE to report only the first quality metric of the DL beam.
Clause 4: The method of Clause 2, wherein the configuration configures the UE to report only the second quality metric of the UL beam.
Clause 5: The method of Clause 2, wherein: the configuration configures the UE to report the first quality metric of the DL beam and the second quality metric of the UL beam.
Clause 6: The method of Clause 2, further comprising: determining the first quality metric based on a first periodic or semi-persistently scheduled CSI-RS; and determining the second quality metric based on a second periodic or semi-persistently scheduled CSI-RS that is different from the first periodic or semi-persistently scheduled CSI-RS
Clause 7: The method of Clause 6, further comprising: receiving a configuration of the first periodic or semi-persistently scheduled CSI-RS and the second periodic or semi-persistently scheduled CSI-RS.
Clause 8: The method of Clause 2, further comprising: determining the first quality metric or the second quality metric based on an aperiodic CSI-RS.
Clause 9: The method of Clause 2, further comprising: determining the first quality metric based on a first aperiodic CSI-RS; and determining the second quality metric based on a second aperiodic CSI-RS that is a repetition of the first aperiodic CSI-RS.
Clause 10: The method of Clause 2, further comprising: determining the first quality metric based on an aperiodic CSI-RS; and determining the second quality metric based on the aperiodic CSI-RS.
Clause 11: The method of any one of Clauses 1-10, wherein obtaining the indication comprises transmitting an UL signal via the UL beam to a network entity and receiving, from the network entity, a DL signal via the DL beam.
Clause 12: The method of Clause 11, wherein reporting the beam quality comprises transmitting a report comprising a quality metric of the DL beam and an indicator that the UL beam is decoupled from the DL beam.
Clause 13: The method of Clause 11, wherein reporting the beam quality comprises transmitting a report comprising a first quality metric of the DL beam, a second quality metric of the UL beam, and an indicator that the UL beam is decoupled from the DL beam.
Clause 14: The method of Clause 11, further comprising: determining a first quality metric of the DL beam based on a periodic or semi-persistently scheduled CSI-RS received at a first time; and determining a second quality metric of the UL beam based on the periodic or semi-persistently scheduled CSI-RS received at a second time that is different from the first time.
Clause 15: The method of Clause 14, further comprising: determining the first quality metric based on a first aperiodic CSI-RS; and determining the second quality metric based on a second aperiodic CSI-RS that is a repetition of the first aperiodic CSI-RS.
Clause 16: The method of Clause 14, further comprising: determining the first quality metric based on an aperiodic CSI-RS; and determining the second quality metric based on the aperiodic CSI-RS.
Clause 17: A method for wireless communications by a network entity, comprising: sending an indication to report beam quality of an UL beam and a DL beam that are decoupled; and receiving a report of a beam quality of at least one of the UL beam or the DL beam according to the indication.
Clause 18: The method of Clause 17, wherein: sending the indication comprises transmitting a configuration to report a first quality metric of the DL beam or a second quality metric of the UL beam; and receiving the report comprises receiving the report according to the configuration.
Clause 19: The method of Clause 18, wherein the configuration configures a UE to report only the first quality metric of the DL beam.
Clause 20: The method of Clause 18, wherein the configuration configures a UE to report only the second quality metric of the UL beam.
Clause 21: The method of Clause 18, wherein: the configuration configures a UE to report the first quality metric of the DL beam and the second quality metric of the UL beam.
Clause 22: The method of Clause 18, wherein: the first quality metric is based on a first periodic or semi-persistently scheduled CSI-RS; and the second quality metric is based on a second periodic or semi-persistently scheduled CSI-RS that is different from the first periodic or semi-persistently scheduled CSI-RS.
Clause 23: The method of Clause 22, further comprising: transmitting a configuration of the first periodic or semi-persistently scheduled CSI-RS and the second periodic or semi-persistently scheduled CSI-RS.
Clause 24: The method of Clause 18, wherein the first quality metric or the second quality metric is based on an aperiodic CSI-RS.
Clause 25: The method of Clause 18, wherein: the first quality metric is based on a first aperiodic CSI-RS; and the second quality metric is based on a second aperiodic CSI-RS that is a repetition of the first aperiodic CSI-RS.
Clause 26: The method of Clause 18, wherein: the first quality metric is based on an aperiodic CSI-RS; and the second quality metric is based on the aperiodic CSI-RS.
Clause 27: The method of any one of Clauses 17-26, wherein sending the indication comprises receiving an UL signal via the UL beam and transmitting a DL signal via the DL beam.
Clause 28: The method of Clause 27, wherein the report comprises a quality metric of the DL beam and an indicator that the UL beam is decoupled from the DL beam.
Clause 29: The method of Clause 27, wherein the report comprises a first quality metric of the DL beam, a second quality metric of the UL beam, and an indicator that the UL beam is decoupled from the DL beam.
Clause 30: The method of Clause 27, wherein: a first quality metric of the DL beam is based on a periodic or semi-persistently scheduled CSI-RS transmitted at a first time; and a second quality metric of the UL beam is based on the periodic or semi-persistently scheduled CSI-RS transmitted at a second time that is different from the first time.
Clause 31: The method of Clause 30, wherein: the first quality metric is based on a first aperiodic CSI-RS; and the second quality metric is based on a second aperiodic CSI-RS that is a repetition of the first aperiodic CSI-RS.
Clause 32: The method of Clause 30, wherein: the first quality metric is based on an aperiodic CSI-RS; and the second quality metric is based on the aperiodic CSI-RS.
Clause 33: An apparatus, comprising: a memory comprising executable instructions; and a processor configured to execute the executable instructions and cause the apparatus to perform a method in accordance with any one of Clauses 1-32.
Clause 34: An apparatus, comprising means for performing a method in accordance with any one of Clauses 1-32.
Clause 35: A non-transitory computer-readable medium comprising executable instructions that, when executed by a processor of an apparatus, cause the apparatus to perform a method in accordance with any one of Clauses 1-32.
Clause 36: A computer program product embodied on a computer-readable storage medium comprising code for performing a method in accordance with any one of Clauses 1-32.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a user equipment (UE), comprising:
obtaining an indication to report beam quality of an uplink (UL) beam and a downlink (DL) beam that are decoupled; and
reporting a beam quality of at least one of the UL beam or the DL beam according to the indication.

2. The method of claim 1, wherein:
obtaining the indication comprises receiving a configuration to report a first quality metric of the DL beam or a second quality metric of the UL beam; and
reporting the beam quality comprises transmitting a report according to the configuration.

3. The method of claim 2, wherein the configuration configures the UE to report only the first quality metric of the DL beam.

4. The method of claim 2, wherein the configuration configures the UE to report only the second quality metric of the UL beam.

5. The method of claim 2, wherein:
the configuration configures the UE to report the first quality metric of the DL beam and the second quality metric of the UL beam.

6. The method of claim 2, further comprising:
determining the first quality metric based on a first periodic or semi-persistently scheduled channel state information (CSI) reference signal (CSI-RS); and
determining the second quality metric based on a second periodic or semi-persistently scheduled CSI-RS that is different from the first periodic or semi-persistently scheduled CSI-RS.

7. The method of claim 6, further comprising:
receiving a configuration of the first periodic or semi-persistently scheduled CSI-RS and the second periodic or semi-persistently scheduled CSI-RS.

8. The method of claim 2, further comprising:
determining the first quality metric or the second quality metric based on an aperiodic channel state information (CSI) reference signal (CSI-RS).

9. The method of claim 2, further comprising:
determining the first quality metric based on a first aperiodic channel state information (CSI) reference signal (CSI-RS); and
determining the second quality metric based on a second aperiodic CSI-RS that is a repetition of the first aperiodic CSI-RS.

10. The method of claim 2, further comprising:
determining the first quality metric based on an aperiodic channel state information (CSI) reference signal (CSI-RS); and
determining the second quality metric based on the aperiodic CSI-RS.

11. The method of claim 1, wherein obtaining the indication comprises transmitting an UL signal via the UL beam to a network entity and receiving, from the network entity, a DL signal via the DL beam.

12. The method of claim 11, wherein reporting the beam quality comprises transmitting a report comprising a quality metric of the DL beam and an indicator that the UL beam is decoupled from the DL beam.

13. The method of claim 11, wherein reporting the beam quality comprises transmitting a report comprising a first quality metric of the DL beam, a second quality metric of the UL beam, and an indicator that the UL beam is decoupled from the DL beam.

14. The method of claim 11, further comprising:
determining a first quality metric of the DL beam based on a periodic or semi-persistently scheduled channel state information (CSI) reference signal (CSI-RS) received at a first time; and
determining a second quality metric of the UL beam based on the periodic or semi-persistently scheduled CSI-RS received at a second time that is different from the first time.

15. The method of claim 14, further comprising:
determining the first quality metric based on a first aperiodic channel state information (CSI) reference signal (CSI-RS); and
determining the second quality metric based on a second aperiodic CSI-RS that is a repetition of the first aperiodic CSI-RS.

16. The method of claim 14, further comprising:
determining the first quality metric based on an aperiodic channel state information (CSI) reference signal (CSI-RS); and
determining the second quality metric based on the aperiodic CSI-RS.

17. A method for wireless communications by a network entity, comprising:
sending an indication to report beam quality of an uplink (UL) beam and a downlink (DL) beam that are decoupled; and
receiving a report of a beam quality of at least one of the UL beam or the DL beam according to the indication.

18. The method of claim 17, wherein:
sending the indication comprises transmitting a configuration to report a first quality metric of the DL beam or a second quality metric of the UL beam; and
receiving the report comprises receiving the report according to the configuration.

19. The method of claim 18, wherein the configuration configures a user equipment (UE) to report only the first quality metric of the DL beam.

20. The method of claim 18, wherein the configuration configures a user equipment (UE) to report only the second quality metric of the UL beam.

21. The method of claim 18, wherein:
the configuration configures a user equipment (UE) to report the first quality metric of the DL beam and the second quality metric of the UL beam.

22. The method of claim 18, wherein:
the first quality metric is based on a first periodic or semi-persistently scheduled channel state information (CSI) reference signal (CSI-RS); and
the second quality metric is based on a second periodic or semi-persistently scheduled CSI-RS that is different from the first periodic or semi-persistently scheduled CSI-RS.

23. The method of claim 22, further comprising:
transmitting a configuration of the first periodic or semi-persistently scheduled CSI-RS and the second periodic or semi-persistently scheduled CSI-RS.

24. The method of claim 18, wherein the first quality metric or the second quality metric is based on an aperiodic channel state information (CSI) reference signal (CSI-RS).

25. The method of claim 18, wherein:
the first quality metric is based on a first aperiodic channel state information (CSI) reference signal (CSI-RS); and
the second quality metric is based on a second aperiodic CSI-RS that is a repetition of the first aperiodic CSI-RS.

26. The method of claim 18, wherein:
the first quality metric is based on an aperiodic channel state information (CSI) reference signal (CSI-RS); and
the second quality metric is based on the aperiodic CSI-RS.

27. The method of claim 17, wherein sending the indication comprises receiving an UL signal via the UL beam and transmitting a DL signal via the DL beam.

28. The method of claim 27, wherein the report comprises a quality metric of the DL beam and an indicator that the UL beam is decoupled from the DL beam.

29. A user equipment configured for wireless communications, comprising:
a memory comprising computer-executable instructions; and
a processor configured to execute the computer-executable instructions and cause the user equipment to:
obtain an indication to report beam quality of an uplink (UL) beam and a downlink (DL) beam that are decoupled; and
report a beam quality of at least one of the UL beam or the DL beam according to the indication.

30. A network entity configured for wireless communications, comprising:
a memory comprising computer-executable instructions; and
a processor configured to execute the computer-executable instructions and cause the network entity to:
send an indication to report beam quality of an uplink (UL) beam and a downlink (DL) beam that are decoupled; and
receive a report of a beam quality of at least one of the UL beam or the DL beam according to the indication.
